(19) United States
(12) Patent Application Publication
(10) Pub. No.: US 2012/0306752 A1
(43) Pub. Date: Dec. 6, 2012

(54) TOUCHPAD AND KEYBOARD

(75) Inventors: Satoshi Hosoya, Yokohama-shi (JP); Hiroaki Agata, Yokohama-shi (JP); Fusanobu Nakamura, Yamato-shi (JP)

(73) Assignee: LENOVO (SINGAPORE) PTE. LTD., Singapore (SG)

(21) Appl. No.: 13/151,047

(22) Filed: Jun. 1, 2011

(51) Int. Cl. G06F 3/02

(52) U.S. Cl. 345/168

(57) ABSTRACT

A method and apparatus is provided for switching between a regular keyboard mode and a touchpad mode for a user to input data. The keyboard may comprise a key which has a touch surface and a sensor. The touch surface may be responsive to pressing by an object to select one of selections associated with the key. The sensor may be used to detect a location where the object is positioned on the touch surface.

### BACKGROUND OF THE INVENTION

The present invention relates generally to methods and apparatus for data input, and, more specifically, to touch sensitive input devices which are located on a keyboard for data input to computers and other instruments.

Keyboards and pointing devices are common touch sensitive input devices for computers, laptops, cell phones, PDAs (personal digital assistants) and other electronic devices. Users may employ a pointing device, such as a mouse, trackball, touchpad, or touch screen, to move a cursor on the screen to make selections. There have been several efforts to incorporate computer cursor or pointer control (mouse functions) into a keyboard. Many of these efforts have been made on a laptop and often include a resistive or capacitive touchpad located below the spacebar.

Touchpads offer a promise of having a spatial correspondence to the surface of the computer screen, so as the finger moves around the touchpad, the cursor or pointer on the screen moves correspondingly to a new position. However, the touchpads may be inconvenient because they may require an interrupting motion by the user to move the fingers or hand from a resting or home position on the keyboard to the location of the pointing device, which may be a significant change in the user's typing behavior.

Therefore, it can be seen that there is a need for a convenient method and system of inputting data.

### SUMMARY

In one aspect, a keyboard comprises a key having a touch surface which, in a first mode, is responsive to pressing by an object to choose one selection associated with the key; a sensor to detect, in a second mode, location where the object slides on the touch surface.

In another aspect, a method for data input comprises sensing movement of an object on a touch surface of a key; and determining a keyboard mode or a touchpad mode of the key by sensing movement of the object.

In a further aspect, a computer readable medium having computer usable program code embodied therewith, the computer program code comprises computer program code configured to sense a movement by an object on a top surface of a key; and computer program code configured to switch operation between a keyboard mode and a touchpad mode based on the movement by the object on the top surface of the key.

These and other features, aspects and advantages of the present invention will become better understood with reference to the following drawings, description and claims.

### BRIEF DESCRIPTION OF THE DRAWINGS

FIG. 1A is an exploded perspective view of an exemplary embodiment of a notebook PC;

FIG. 2A is a top view of an exemplary embodiment of a keyboard used in a touchpad mode;

FIG. 2B is a top view of another exemplary embodiment of a keyboard;

FIG. 2C is a top view of the exemplary embodiment of a keyboard used in keyboard mode;

FIG. 3A is a cross-sectional view of an exemplary embodiment of a key;

FIG. 3B is a cross-sectional view of another exemplary embodiment of a key;

FIG. 3C is a top view of the exemplary embodiment of the key shown in FIG. 3A; and

FIG. 4 is a flow chart of an exemplary process of switching between a keyboard mode and a touchpad mode.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments provide methods and systems for inputting data. Exemplary embodiments may include a keyboard having one or more integrated keys which can be used as a data input device in a keyboard mode and in a touchpad mode. The integrated key may have a key top covering a plurality of keys of a typical keyboard. In the keyboard mode, the touch surface may detect a user's pressing movement and may send a signal to a computing device that the user has pressed a key that would be typically located at the position the user depressed. In the touchpad mode, the touch surface of the integrated key may detect a user's movement, for example, and in response, a cursor or pointer on a screen of a computing device moves correspondingly to a new position. More specifically, in one exemplary embodiment, the “T, Y, G, H” keys may be integrated as a single key top with the touch surface having a touch sensor built in.

With a click on a button, which may be disposed under the space bar, for example, users may switch the integrated key between the touchpad mode and the keyboard mode. In another exemplary embodiment, the integrated key may switch between the keyboard mode and the touchpad mode automatically by sensing the user's activity on the touch surface. For example, a slide movement may be detected and cause the integrated key to be in the touchpad mode, whereas a key depression movement may be detected and cause the integrated key to be in the keypad mode.

In the touchpad mode, users may control a cursor on a display screen by sliding an object, e.g., a stylus, for example, on the touch surface. In keyboard mode, users may type in the characters “T, Y, G, H”, as usual. Even though there is only one integrated key top, in the keypad mode, touch sensor may detect a user's finger or object position when he or she presses the key top and decide which character may be typed. In another exemplary embodiment, the keyboard may have two integrated key tops, with one replacing the “R, T, F, G” keys and another replacing the “Y, U, H, J” keys. The keyboard having two integrated key tops may have a wider touch area.

Exemplary embodiments may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, exemplary embodiments may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction performance system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wired, wire line, optical fiber cable, RF, etc.

Computer program code for carrying out operations of exemplary embodiments may be written in any combination of one or more programming languages, including an object oriented programming language such as Java™, Smalltalk™, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

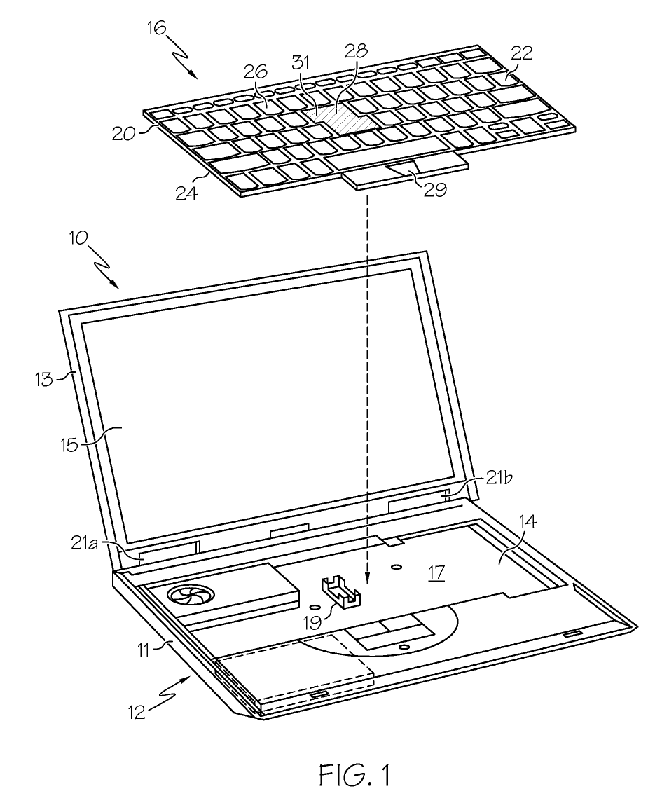

FIG. 1 is an exploded perspective view of an exemplary embodiment of a notebook PC 10. The notebook PC 10 may be a laptop computer system, such as one of the ThinkPad® series of personal computers sold by Lenovo (US) Inc. of Morrisville, N.C., or a workstation computer, such as the ThinkStation®, which is sold by Lenovo (US) Inc. of Morrisville, N.C. The notebook PC 10 may have a liquid crystal display (LCD) 15 accommodated in a display casing 13. A bottom case 11 may have a bottom wall 12 and a recessed portion 14 opposing the bottom wall 12. The bottom case 11 may further accommodate system devices, such as a printed circuit board (PCB) 17. A keyboard unit 16 may be adapted for installation in the notebook PC 10. The keyboard unit 16 may be attached to the bottom case 11 so as to cover the recessed portion 14 of the bottom case 11. The bottom case 11 and the display casing 13 may be openably coupled to each other via hinge portions 21a and 21b.

Still in FIG. 1, the keyboard unit 16 may comprise a keyboard body 20 which may include a top face 22 and a bottom face 24. The bottom face 24 of the keyboard body 20 may be disposed towards the bottom case 11 or the printed circuit board 17 of the notebook PC 10 when installed therein. The keyboard unit 16 may be electrically connected to a terminal part 19 of the printed circuit board 17.

Keyboard 16 may include a number of keys, such as key 26, which may be disposed on the top face 22 of the keyboard body 20. Each key 26 on keyboard 16 may be pressed (or actuated), for example, to select or input a specific key input, such as a character, letter, number, control input, etc.

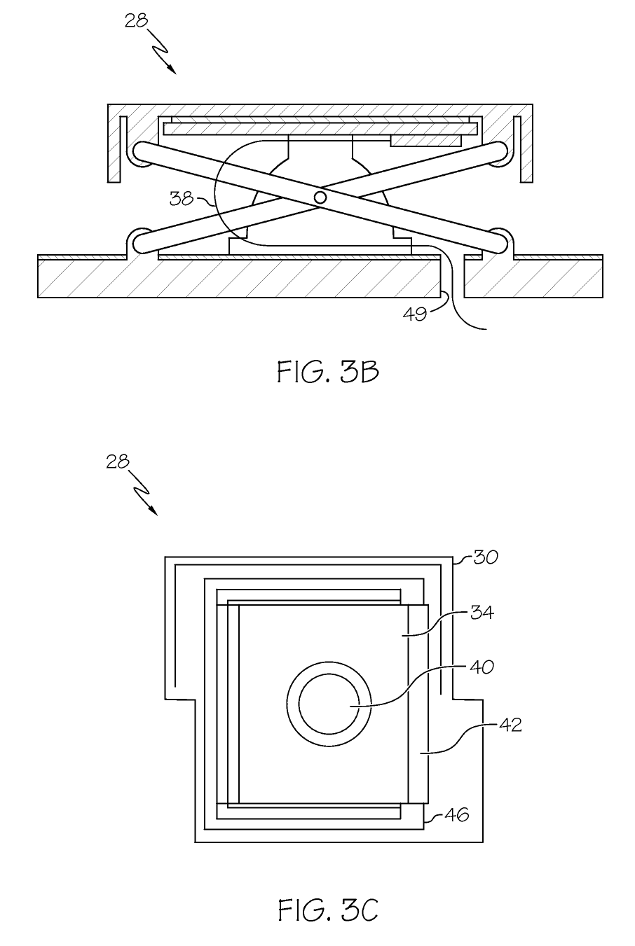

In an exemplary embodiment, the keyboard 16 may include an integrated key 28 which may replace a T key, a Y key, a G key, and an H, for example. However, the integrated key 28 may replace a combination of a number of keys on the keyboard, e.g., two keys, three keys, four keys, or five keys, for example. The integrated key 28 (or keys) may have a key top 30 (shown in FIG. 3A). The key top 30 may have a touch sensor which may be a conventional sensor to detect touch or contact to the integrated key 28. In one exemplary embodiment, a touch sensor may be a single capacitive sensor (rather than multiple traces or cells per key). When the keyboard 16 is in the touchpad mode, the integrated key 28 may be used as a touchpad. The touchpad may be any type of touchpad, which are generally well known (e.g., capacitive, resistive, or electromagnetic touchpads). For example, touchpad 31 may be capacitive touchpad, which may include typically a two-dimensional grid of intersecting conductive traces in the X and Y directions. When a finger or other object contacts the touchpad, the circuitry, which may be disposed on the printed circuit board (PCB) 17, may respond to the sensor of the integrated key 28 and determine the touched position on the touchpad 31 by sensing a change in capacitance in both X and Y directions, for example.

The keyboard 16 having the integrated key 28 (or keys) with a touchpad base 32 under the key top 30 may be useful for a variety of applications. Such a keyboard, with the integrated key and touchpad, may enable cursor control, typically performed by a mouse. Other exemplary applications for such a keyboard may include vertical and horizontal scrolling, 3D rotation, document navigation, gaming applications, pressure sensitive input, and multi-degree of freedom input. Another application for use with keyboard 16 may include computer control other than cursor control, such as finger-based gesture shortcuts for menu selections, e.g., drawing an “O” across the integrated key 28 to do an “Open File” command or menu pick.

According to another exemplary embodiment, the keyboard 16 may also be useful for one or more output applications, or combined input/output applications. For example, an additional touchpad or touch sensor or thin film device may be provided on one or more keys to provide tactile feedback to the user, such as, for example, providing a piezoelectric vibration strip or a thermal strip (to increase or decrease temperature) on one or more keys. For example, these types of tactile sensors may allow the user to receive a tactile or physical indication of a certain event or occurrence, such as allowing the user to feel for document or page boundaries, or indicate section boundaries, to notify the user of certain document contents before they appear on the page or screen, or to provide physical or tactile feedback to a blind user of the keyboard, for example.

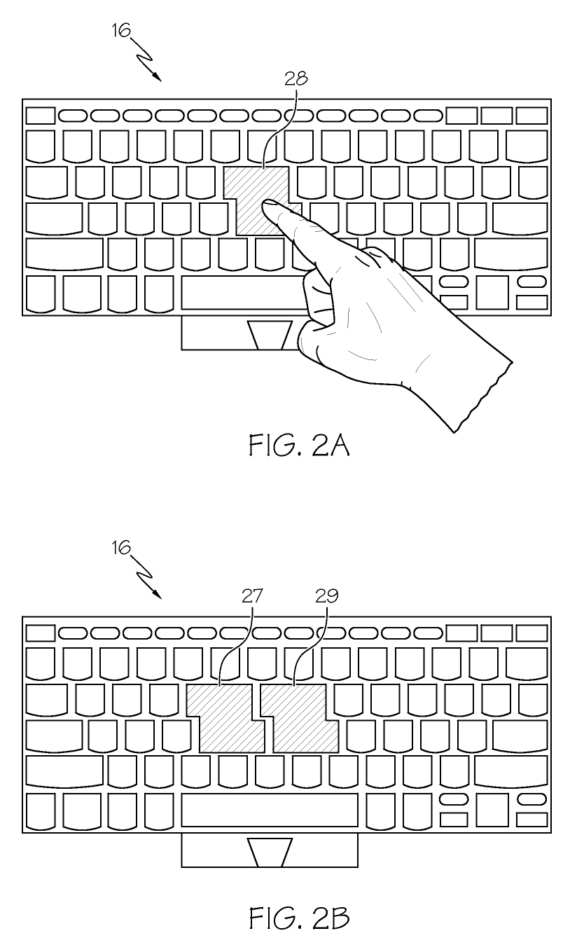

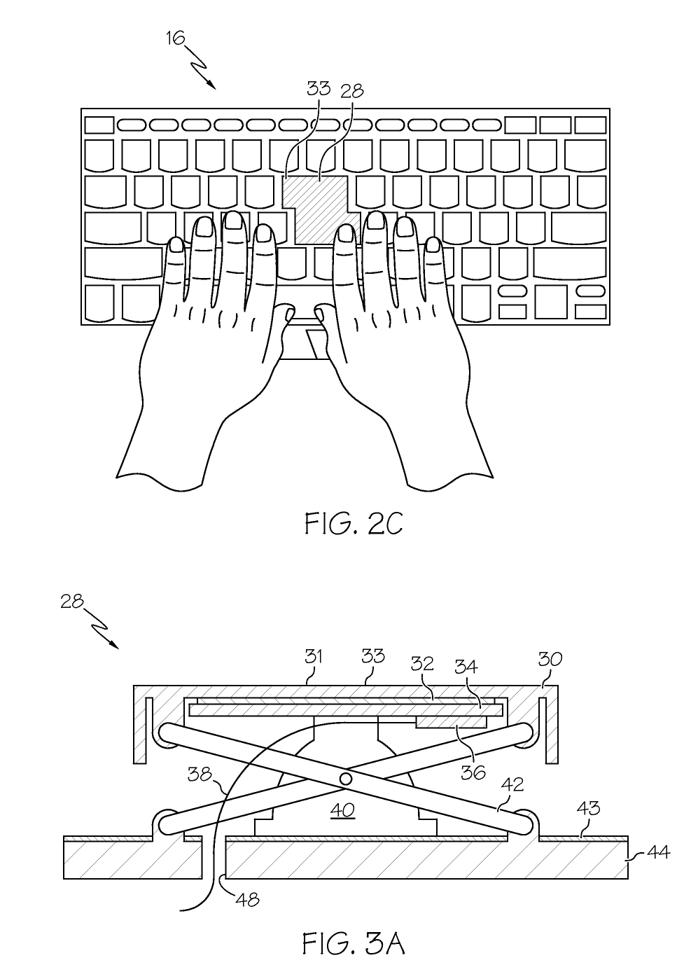

Referring to FIG. 2A, when the keyboard 16 is in a touchpad mode, the integrated key 28 may allow pointer or cursor control or movement by moving (or dragging) a finger or another object across a top surface of the integrated key 28. By having the integrated key 28 on the keyboard 16, a convenient interface may be provided since users may not necessarily be required to move their fingers or hands from their home or ordinary position on the keyboard when controlling or moving a pointer or cursor or performing mouse type functions.

In an exemplary embodiment, the integrated key 28 on the keyboard 16 may be adapted to allow at least small-scale (e.g., relatively short distance) and/or precise (or fine) pointer control (e.g., under an index finger or adjacent to an index finger) due to the small size and relatively high resolution of the touchpad 31, for example. A user may be able to accurately move the pointer to a specific location using the integrated key 28, but due to the relatively small size of the integrated key 28, in some cases it may take several clutches or swipes (e.g., finger lift and retrace across the integrated key 28) to move the pointer across a significant portion of the screen distance (e.g., across the entire display screen), according to an exemplary embodiment. Although in other embodiments, the integrated key 28 may allow a user to move a pointer a significant distance across a screen in one swipe.

In another exemplary embodiment, two integrated keys 27 and 29, as shown in FIG. 2B, may be provided and may allow, for example, large-scale (e.g., relatively longer distance) or gross pointer control by moving a finger or other object across top surfaces of keys 27 and 29. A combination of two integrated keys 27 and 29 may provide a convenient touchpad system that provides both precise or fine pointer control over short distances (e.g., via a single key 27 or 29) and allows gross pointer control or pointer control over longer distance (e.g., via two keys 27 and 29). The integrated key 27 may be positioned in place of a R key, a T key, an F key, and a G key, for example. Similarly, the integrated key 29 may be positioned in place of a Y key, a U key, an H key, and a J key, for example.

As shown in FIG. 2C, when the keyboard 16 is in the keyboard mode, users may use a finger or an object to press the touch surface 33 of the integrated key 28 to choose one selection associated with the key, such as characters “T, Y, G, H”, for example. For example, users may press or actuate a lower left quarter of the integrated key 28 to input the character G. Similarly, users may press or actuate an upper left quarter, an upper right quarter, or a lower right quarter of the integrated key 28 to input the character “T”, “Y”, or “H” respectively.

Referring to FIG. 3A, a mechanical architecture of the integrated key 28 may include the key top 30 and the touchpad base 34, which may be taped by double side tape 32, for example, to the key top 30. Alternatively, the touchpad base 34 may be glued to the key top 30. A touch sensor (not shown) may be provided on the top surface of the touchpad base 34 to detect touch or contact to the integrated key 28. In one exemplary embodiment, a touch sensor may be a single capacitive sensor (rather than multiple traces or cells per key). The integrated key 28 may include a pantograph 42, which can move up and down. The integrated key 28 may further include a connector 36, a cable 38, e.g., flexible flat cables (FFC) or flexible printed cable (FPC), connecting the connector 36 to circuitry, e.g., the printed circuit board (PCB) 17 (shown in FIG. 1), for example, through an aperture 48. One or more membrane sheets 43 with conductive traces thereon may be provided. The integrated key 28 may include a rubber dome 40 connecting the touchpad base 34 and the membrane sheets 43. A bottom base plate 44 may be provided beneath the membrane sheets 43.

In one exemplary embodiment, the pantograph 42 may be pressed, pushing against and partially collapsing rubber dome 40 so that conductive traces in different layers of membrane sheets 43 may be pushed together (shorted) to provide an indication that the integrated key 28 has been pressed (or actuated). In addition, touch signals from touchpad 34 may be routed from the connector 36 to the PCB 17 via FFC or FPC 38. FCC or FPC 38 may be routed across the rubber dome 40 and the pantograph 42 through the aperture 48 on the base plate 44, as shown in FIG. 3A. According to another exemplary embodiment, as shown in FIG. 3B, the FFC or FPC 38 may be routed through an aperture 49, which may be located under the connector 36.

Due to movement or travel of integrated key 28, the FFC or FPC 38 may include folds, bends, coils, curves or other structures to allow for flexing or bending of FFC or FPC 38 during travel of the pantograph 42. A stabilizer 46, as shown in FIG. 3C, may be used to prevent the key top 30 from tilting or revolving. The stabilizer 46, which may be made of metal wire, may limit movement or travel of the pantograph 42.

Still in FIG. 3C, according to an exemplary embodiment, the touchpad base 34 may have a size of four keys, for example. The top of the rubber dome 40 may be situated at the center of the touchpad base 34, for example.

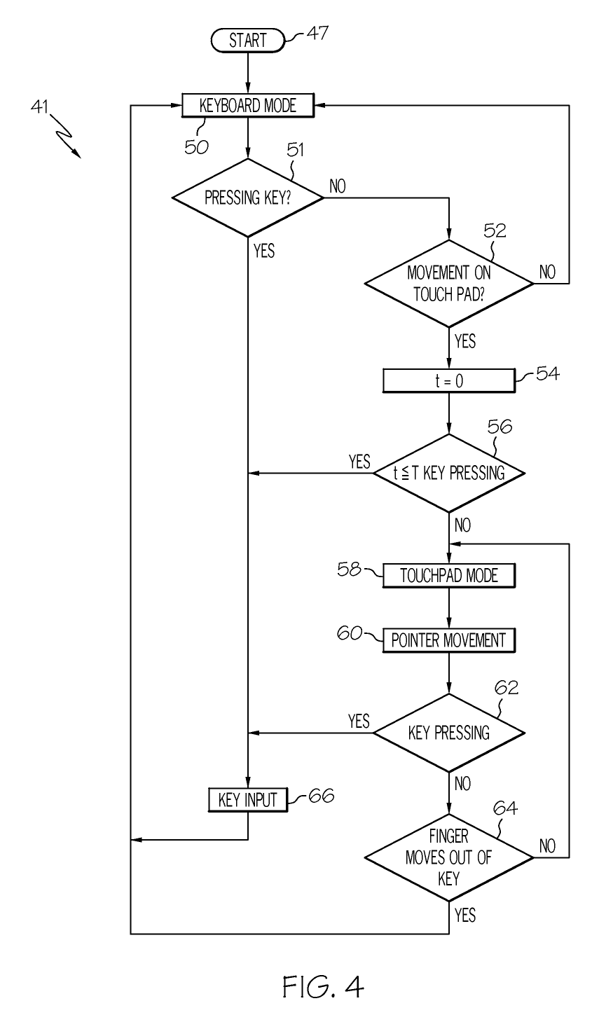

FIG. 4 is a flow chart 41 of an exemplary process of switching between a keyboard mode and a touchpad mode. When an apparatus equipped with the keyboard 16 is turned on or started in a step 47, the keyboard may be in the keyboard mode in a step 50. When a key has been pressed in a step 51, then key input in a step 66 may be enabled and touchpad mode input may be disabled for a predetermined period of time after each key has been pressed. Otherwise, if a key has not been pressed, it is determined if there is a slide movement on the touchpad in a step 52.

If it is determined that there has been no slide movement on the touchpad, the keyboard may be switched to the keyboard mode in the step 50. If it is determined that there is slide movement on the touchpad, an algorithm may start counting time at t=0 in a step 54. Here, “t” refers to the time the object stays on the touchpad since “t” was reset in the step 54. If it is determined that “t” is equal or shorter than “T”, the key input in a step 66 may be enabled. Here, “T” refers to a threshold time, which may be predetermined according to the apparatus. If it is determined that “t” is longer than “T”, the keyboard may be in touchpad mode in a step 58.

As the object moves around the touchpad in touchpad mode, a cursor or pointer on a display screen may move correspondingly to a new position in a step 60. If it is determined that a key on the keyboard has been pressed, then the touchpad mode may be disabled and key input in step 66 may be enabled. If it is determined that a key on the keyboard has not been pressed and the finger or the object has moved off of the key, the keyboard may be in the keyboard mode in step 50. If it is determined that the finger or the object has not moved out of the key, the keyboard may still be in the touchpad mode in step 58.

Alternative to the automatic switching between the keyboard mode and the touchpad mode, as described above in FIG. 4, users may manually click a key on the keyboard, e.g., a space bar, or a button 29 (shown in FIG. 1) to allow users to select a keyboard mode, for example, and to toggle between the keyboard mode and the touchpad mode.

It should be understood, of course, that the foregoing relate to exemplary embodiments of the invention and that modifications may be made without departing from the spirit and scope of the invention as set forth in the following claims.

We claim:

1. A keyboard, comprising:
a first key having
a touch surface which, in a first mode, is responsive to pressing by an object to choose one selection associated with the key; and
a sensor to detect, in a second mode, a location where the object slides on the touch surface.

2. The keyboard of claim 1, further comprising a second key which can be manipulated by the object to switch the first key between the first mode and the second mode.

3. The keyboard of claim 1, further comprising a touchpad base for detecting touching by the object.

4. The keyboard of claim 1, wherein the first mode is a keyboard mode and the second mode is a touchpad mode.

5. The keyboard of claim 1, wherein the movement on the touch surface of the first key by the object determines whether the keyboard is in the first mode or a second mode.

6. The keyboard of claim 1, wherein the first key is an integrated key having a key top covering a plurality of keys on the keyboard.

7. The keyboard of claim 6, wherein selections associated with the key are determined by a depressing position of the object on the touch surface of the key.

8. The keyboard of claim 6, wherein the plurality of keys comprise a T key, a Y key, a G key, and an H key.

9. The keyboard of claim 1, wherein the key is two integrated keys that have a key top covering a plurality of keys on the keyboard.

10. A method for data input, comprising:
sensing movement of an object on a touch surface of a key; and
determining a keyboard mode or a touchpad mode of the key by sensing movement of the object.

11. The method of claim 10, further comprising recognizing finger-based gesture shortcuts on the touch surface of the key in touchpad mode.

12. The method of claim 10, further comprising displaying a cursor or a pointer movement on a display screen corresponding to the movement of the object on the top surface of the key in the touchpad mode.

13. The method of claim 10, further comprising providing a key input when the key has been pressed by the object to choose one selection associated with the key in the keyboard mode.

14. The method of claim 10, further comprising displaying a key input when the key has been pressed by the object to choose one selection associated to the first key on a display screen in the keyboard mode.

15. A computer readable medium having computer usable program code embodied therewith, the computer program code comprising:
computer program code configured to sense a movement by an object on a surface of a key; and
computer program code configured to switch operation between a keyboard mode and a touchpad mode based on the movement by the object on the surface of the key.

16. The computer program code of claim 15 further comprising computer program code configured to switch the keyboard mode to the touchpad mode if there is a slide movement on the top surface of the key.

17. The computer program code of claim 15 further comprising computer program code configured to display a cursor or a pointer on a display screen corresponding to the movement of the object on the top surface of the key in the touchpad mode.

18. The computer program code of claim 15 further comprising computer program code configured to switch the touchpad mode to the keyboard mode when the object leaves the key.

19. The computer program code of claim 15 further comprising computer program code configured to switch the touchpad mode to the keyboard mode when a keyboard is turned on.

20. The computer program code of claim 15 further comprising computer program code configured to switch the touchpad mode to the keyboard mode when the object presses the key.
